(19) United States
(12) Patent Application Publication
(10) Pub. No.: US 2017/0097272 A1
(43) Pub. Date: Apr. 6, 2017

(54) PIPELINE MONITORING AND MANAGING SYSTEMS AND METHODS THEREOF

(71) Applicant: Mohammed Zulfiquar, Birmingham (GB)

(72) Inventor: Mohammed Zulfiquar, Birmingham (GB)

(21) Appl. No.: 14/874,648

(22) Filed: Oct. 5, 2015

(51) Int. Cl. G01M 3/02; G08B 21/18

(52) U.S. Cl. CPC G01M 3/02; G08B 21/18

(57) ABSTRACT

Methods and systems for monitoring and managing pipelines are disclosed. A system may include a movable monitoring device for scanning a pipeline including a first end and a second end. The monitoring device is disposable onto an external surface of the pipeline. The monitoring device includes a scanning device for scanning the pipeline and sensing parameter associated with the pipeline. The system also includes a data processing device communicably coupled to the movable monitoring device. The data processing device may be configured to receive the parameters associated with the pipeline and generate related information of the pipeline based on the parameters.

### FIELD OF THE INVENTION

The present invention generally relates to the field of pipeline monitoring and protection, and more particularly, to an integrated pipeline monitoring and protection system including a movable monitoring device and method of its use and manufacture.

### BACKGROUND OF THE INVENTION

Pipelines are most significant mode for transporting fluid fuels, such as Oil and Gas; equally significant is it's monitoring and protection from various unwanted issues, such as leakage, theft etc. Such unwanted issues directly or indirectly affect the oil and gas communities and environment throughout the world. In Nigeria alone, for instance, oil pipeline theft reduces output by approximately 15% per annum representing a loss of more than $7 billion. Due to the sensitivity of these thefts, the true figure may be even greater than the considerable 16,083 recorded pipeline breaks in the last decade. Similarly, leakage in the pipelines is great threat to environment, which badly affects surroundings and living beings around the leakage area.

It is virtually impossible to manufacture an energy pipeline, which is totally immune to metal fatigue or physical failure. Therefore, there will always be risks associated with any pipeline project. Highly toxic substances or severe external environmental conditions can also reduce the life expectancy and reliability of the pipes. For example, the more toxic the liquid is the greater the chances of system failures due to its corrosive nature. On addition external weather factors may also play a major role in the pipes reliability.

Various efforts in past fifty years have been made from time to time to overcome such unwanted issues in selected regions across the pipelines path using methods or tools, such as conducting statistical analysis, performing airborne reconnaissance, regular monitoring of pressure in the pipelines, using Computational Pipeline Monitoring (CPM) software, etc. Further, such methods and tools are limiting in respect of the factors required to be monitored in a particular region of the pipeline for which an exhaustive separate analysis is made on the pipes before its installation. For example, if a pipe in a pipeline is required to be installed in pressure sensitive areas, such as in deep sea or ocean or above the hills, then the pipe is required to be tested under various pressure conditions before installation. After installation, such pipes are installed with such CPM software that is capable of monitoring pressure regularly. In such an event, other parameters relating to the pipeline in those areas may get ignored which risks pipeline failure due to the factors that may not be assumed or have been ignored. It means that the presently available pipelines are always lacking integrity in terms of risk due to various unknown factors that may also result in pipeline leakage, failure or theft at any portion of the entire pipeline.

Furthermore, wherever such methods or tools are installed along the pipelines, they are generally utilized as data collection tools or method which sends all the collected data to a specific data center for processing, which increases the load on the data center and delays the information relevant to the pipeline.

In regard to all the above problems very few innovations have taken place in the pipeline integrity, where the entire pipeline is prevented or monitored on a regular basis and that also reduces such delays in generating data and reducing load on the central servers. This is largely due to the fact that the pipelines were new and risks were determined to be low. In addition, the value of oil or gas was relatively low, at around $10 per barrel, which made pipeline theft virtually non-existent. The world today now has a far different landscape as the price of oil and gas per barrel hovers around $100. Because of the changes, the oil and gas industry is desperate to address the massive financial losses and environmental degradation that are associated with both pipeline theft and leakage. In addition, the pipeline industry is grappling with mounting regulatory pressures.

Today's pipelines are manufactured to a much higher standard with smarter materials designed to last longer but they are still not fail proof. The industry's ultimate goal is to develop zero failure pipelines.

### SUMMARY

The lack of innovation and effective investment in research and development to address the issues mentioned above has meant that the solutions twenty years ago are no different to the ones offered today by servicing companies. Accordingly, there exists a need for innovation in relation to the pipeline integrity, where the entire pipeline is prevented or monitored on a regular basis and that also reduces such delays in generating data and reducing load on the central servers.

The present disclosure describes an integrated pipeline monitoring, protection and managing system that can be fitted on the pipeline. The pipelines are usually utilized for carrying fluids such as oil and gas. This will be presented in the following simplified summary to provide a basic understanding of one or more aspects of the disclosure that are intended to overcome the discussed drawbacks, but to include all advantages thereof, along with providing some additional advantages. This summary is not an extensive overview of the disclosure. It is intended to neither identify key or critical elements of the disclosure, nor to delineate the scope of the present disclosure. Rather, the sole purpose of this summary is to present some concepts of the disclosure, its aspects and advantages in a simplified form as a prelude to the more detailed description that is presented hereinafter.

An object of the present disclosure is to describe an integrated pipeline monitoring and protection system, which will offer real time monitoring and protection of the entire pipeline regarding leakage, theft or even predict future leakage and enables to take preventive measures to avoid such leakage or theft. Another object of the present disclosure is to provide such module that may be installed along the entire pipeline to enable pipeline integrity in terms of protection of the entire pipeline as against the available prior-art technologies, which are largely based on the protection or presentation of specific regions of the pipeline. Another object of the present disclosure is to provide such a module that is capable of monitoring, if required, all the relevant parameters of the pipelines in a cost effective manner as against the available prior-art technologies where specific tools or methods are incorporated on the pipeline which are only required in that region of the pipeline because of huge costs involved in installing all the tools and methods at each location of the pipelines. Another object of the present disclosure is to provide such module or system that is capable of generating real time data of the pipeline and at the same time reduce the processing load on a central server. Various other objects and features of the present disclosure will be apparent from the following detailed description and claims.

The above noted and other objects, in one aspect, may be achieved by an integrated pipeline monitoring and managing system of the present disclosure. The system may include a movable monitoring device configured to scan a pipeline including a first end and a second end. The movable monitoring device is disposable circumferentially onto an external surface of a pipeline. The movable monitoring device may further include a scanning device may include a number of sensors or sensing devices. The scanning device may be configured to scan the external surface of the pipeline between the first end of the pipeline and the second end of the pipeline. The scanning device may also be configured to sense and monitor a number of parameters associated with the pipeline. The pipeline monitoring and managing system may also include a data processing device communicably coupled to the movable monitoring device. The data processing device may be configured to receive the parameters associated with the pipeline and generate related information of the pipeline based on the parameters.

Another embodiment of the present disclosure provides a pipeline monitoring and protection device. The device may include a scanning device including one or more sensors or sensing devices. The scanning device may be configured to scan an external surface of a pipeline including a first end and a second end. The scanning device may also be configured to sense and monitor a number or parameters associated with the pipeline. The scanning device may also be configured to process the parameters for generating a plurality of real time data relating to the pipeline. The device may also include a memory device configured to store the real time data relating to the pipeline. The memory may be configured to store the information and data related to the pipeline over a period of time. The pipeline monitoring and protection device may also include a data processing system configured to determine real time data relating to the pipeline based on the sensed parameters. The data processing device is also configured to process the real time data for generating a number of related information of the pipeline. The pipeline monitoring and protection device may be adapted to fit circumferentially onto the external surface of the pipeline. The pipeline monitoring and protection device may be configured to move longitudinally between the first end and the second end of the pipeline and to move circumferentially with reference to a central axis of the pipeline.

A yet another embodiment of the present disclosure provides a method for making a pipeline monitoring and managing system. The method may include providing a movable monitoring device configured to scan the pipeline. The movable monitoring device may be disposable circumferentially onto an external surface of a pipeline. The movable monitoring device may further include a scanning device including one or more sensors. The scanning device may be configured to scan the external surface of the pipeline; sense and monitor a number of parameters associated with the pipeline. The method may also include providing a data processing device. The data processing device may be communicably coupled to the movable monitoring device for receiving the parameters associated with the pipeline and generating a number of related information of the pipeline based on the parameters.

A further embodiment of the present disclosure provides a method for pipeline monitoring and managing. The method may include scanning, by a movable monitoring device, a pipeline. The movable monitoring device may be configured to be fitted on an external surface of the pipeline and to move over the external surface of the pipeline. The method may also include mapping, by a scanning device of the movable monitoring device, the external surface into a number of sections. The method may also include assigning, by the scanning device, at least one identifier to each of the sections. The method may further include sensing, by scanning device, one or more parameters associated with the pipeline. The method may also include determining, by a data processing device of the movable monitoring device, at least one real time data based on the sensing of the one or more parameters. The method may also include processing, by the data processing device, the at least one real time data for generating at least one information relating to the pipeline. The method may also include comparing, by the data processing device, the generated information with pre-stored information of the pipeline for identifying any deviation in the information. The pre-stored information is stored in a memory device of the movable memory device. The method may furthermore include generating, by a signaling device, an alarming signal when the deviation is identified in the information. The alarming signal may include at least one of an audio signal, a smoke signal, a visual signal, a light signal, a message, and combination of these.

In another aspect, the disclosure also provides a system/module/device, and a method for making the system/module/device being capable of ensuring pipeline protection in a pipeline monitoring and managing system, when configured on the pipeline.

These together with the other aspects of the present disclosure, along with the various features of novelty that characterize the present disclosure, are pointed out with particularity in the present disclosure. For a better understanding of the present disclosure, its operating advantages, and its uses, reference should be made to the accompanying drawings and descriptive matter in which there are illustrated exemplary embodiments of the present disclosure.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1A is a schematic diagram illustrating an exemplary environment including a pipeline, where various embodiments of the present disclosure may function;

FIG. 1B is a schematic diagram illustrating another exemplary environment including a pipeline, where various embodiments of the present disclosure may function;

FIG. 2A is a block diagram illustrating various system elements of an exemplary movable monitoring device for monitoring and managing a pipeline, in accordance with an embodiment of the present disclosure;

FIG. 2B is a block diagram illustrating various system elements of another exemplary movable monitoring device for monitoring and managing a pipeline, in accordance with another embodiment of the present disclosure;

FIG. 3 is a flowchart illustrating an exemplary method for monitoring and managing a pipeline through an exemplary movable monitoring device, in accordance with an embodiment of the present disclosure;

FIG. 4 is a schematic diagram illustrating an exemplary movable monitoring device being fitted on a pipeline, in accordance with an embodiment of the present disclosure; and

FIGS. 5A-5B are diagrams illustrating scanning of the pipeline at various angles, in accordance with different embodiments of the present disclosure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

The functional units described in this specification have been labeled as devices. A device may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Indeed, an executable code of a device could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Although the following description contains many specifics for the purposes of illustration, anyone skilled in the art will appreciate that many variations and/or alterations to these details are within the scope of the present disclosure. Similarly, 5 although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure. Further, the relative terms, 10 such as “first,” “second,” “top,” “bottom,” and the like, herein do not denote any order, elevation or importance, but rather are used to distinguish one element from another. Further, the terms “a” and “an” herein do not denote a limitation of quantity, but rather denote the presence of at least one of the referenced item.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

The device or system for monitoring and managing pipelines may be a software, hardware, firmware, or combination of these. The device or the system is further intended to include or otherwise cover all software or computer programs capable of performing the various heretofore-disclosed determinations, calculations, etc., for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

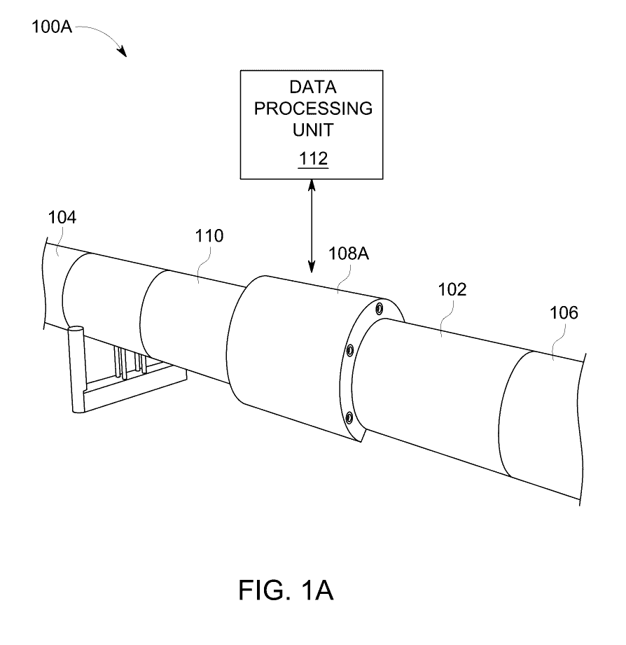

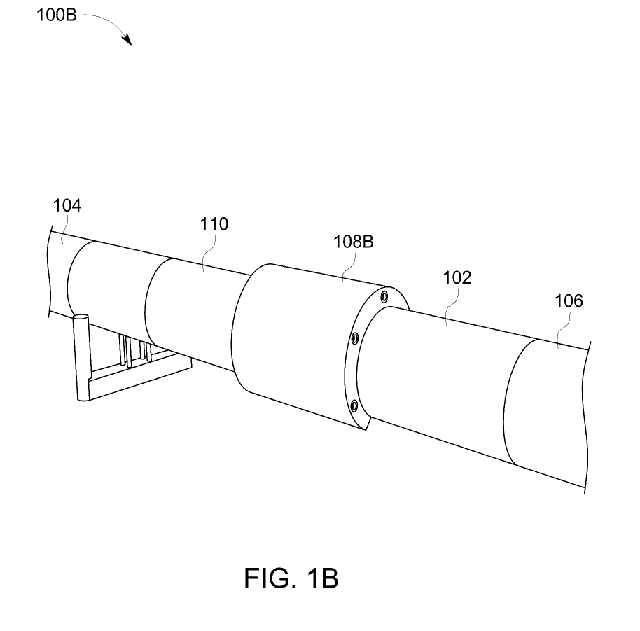

FIG. 1A is a schematic diagram illustrating an exemplary environment 100A, where various embodiments of the present disclosure may function. The environment 100A may primarily include a pipeline 102 having a first end 104 and a second end 106. A movable monitoring device 108 may be disposed or fitted on the pipeline 102. As shown, the monitoring device 108 can be circumferentially fitted onto an external surface 110 of the pipeline 102. In some embodiments, the movable monitoring device 108 may include a scanning device (not shown) including multiple sensors. The sensors may be configured to sense or detect one or more parameters of the pipeline 102. In some embodiments, the scanning device is an embedded software, hardware, firmware, or combination of these that is part of the monitoring device 108. The scanning device may be configured to scan the external surface 110 of the pipeline between the first end 104 and the second end 106 of the pipeline 102. The scanning device may be configured to monitor multiple parameters associated with the pipeline 102. Example of the parameter associated with the pipeline 102 may include all the relevant parameters that are capable of determining any leakage, future leakage or any attempt of theft in the pipeline 102, such as, corrosion in the pipeline, strain created by internal expending force of fluid in the pipeline 102, condition of peripheral interface of the pipeline 102, changes in temperature, pressure, humidity, shocks, vibrations, and toxic gases along with the position along the pipeline 102, and so forth.

The movable monitoring device 108 may be configured to scan the pipeline 102 by moving longitudinally between the first end 104 and the second end 106 of the pipeline 102. In some embodiments, the movable monitoring device 108 may be configured to scan the pipeline 102 by moving circumferentially over the external surface 110 of the pipeline 102. In some embodiments, a user may set the time duration for the scanning by the monitoring device 108. The monitoring device 108 may be configured to scan the pipeline at pre-defined intervals for example, monthly, weekly, daily, and so forth.

The monitoring device 108 may be configured to map the external surface 110 of the pipeline into a number of sections and assign at least one identifier to each of the sections. The identifier(s) may uniquely identify the sections.

The monitoring device 108 may also be configured to measure real time data or values for monitoring the parameters of the sections of the pipeline 102 at pre-defined intervals of time. The monitoring device 108 may also be configured to predict future leakage in the pipeline based on the at least one of the plurality of real time data. Examples of the real time data for estimating future leakage of the pipeline 102 may include, but are not limited to, corrosion in the pipeline 102, strain created by internal expending force of fluid in the pipeline 102, condition of peripheral interface of the pipeline, changes in temperature, pressure, humidity, shocks, vibrations, toxic gases along with the position along the pipeline 102.

The movable monitoring device is also configured to measure real time data relating to the security breach along the pipeline 102. Examples of the real time data relating to security breach may include, such as, but not limiting to, tempering, damage or rupture of the pipeline 102 and position thereof along the pipeline 102.

The movable monitoring device 108 may be communicably coupled to a data processing device 112. The monitoring device 108 may send and receive data to/from the data processing device 112 over a network (not shown). The network may be a wired or a wireless network, or combination of these. In some embodiments, the movable monitoring device 108 may also include a Global Positioning System (GPS) device for coordinating with a GPS satellite to enable the communication with the data processing device 112.

The movable monitoring device 108 may further be configured to generate an alarming signal in event of leakage or security breach of the pipeline 102. The alarming signal may include at least one of an audio, smoke, and visual lights

The movable monitoring device 108 further may also store the data, and the plurality of related information of the pipeline 102.

The data processing device 112 may be configured to receive the multiple parameters or their values associated with the pipeline 102. The data processing device 112 may be configured to process the parameter or their values and generate related information of the pipeline 102 based on the parameter or the parameter values. The data processing device 112 may be configured to compare the related information of the pipeline 102 with pre-stored data

In some embodiments, the data processing device 112 may form a unitary structure with the movable monitoring device 108 and is part of the same. FIG. 1B is a schematic diagram illustrating another exemplary environment 100B including a pipeline, where the monitoring device 108 includes the data processing device integrated within.

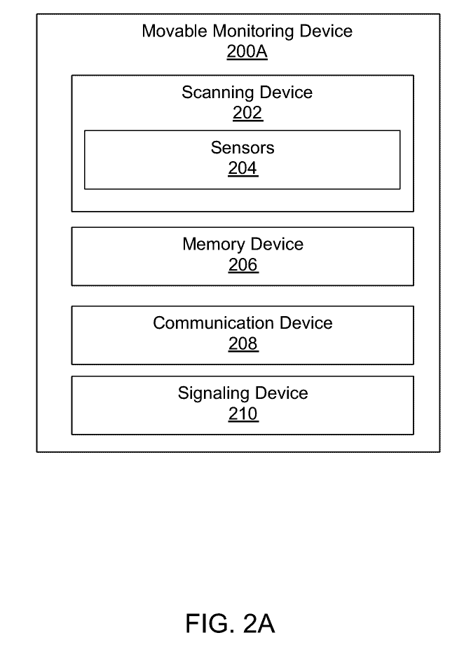

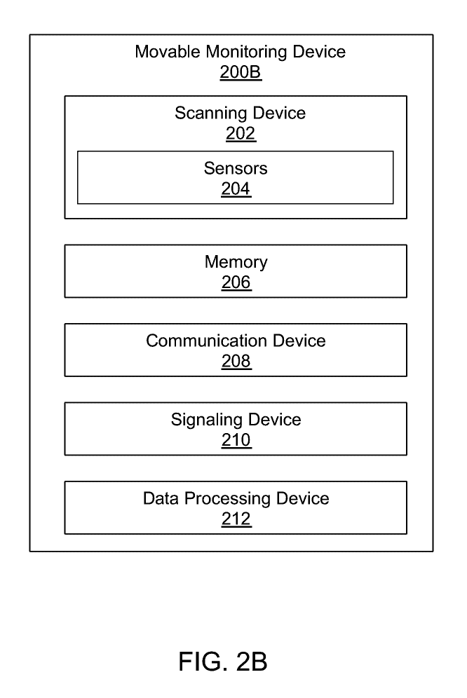

FIG. 2A is a block diagram illustrating various system elements of the exemplary movable monitoring device 200A, in accordance with an embodiment of the present disclosure. As shown, the movable monitoring device 200A primarily may include a scanning device 202 including one or more sensors 204 (or sensing devices), a memory device 206, a communication device 208, and a signaling device 210.

As discussed with reference to FIGS. 1A-1B, the movable monitoring device 200A may be configured to scan the pipeline 102 by moving longitudinally and circumferentially with reference to the external surface 110 of the pipeline 102. The scanning device 202 may include multiple sensors 204 configured to scan and sense multiple parameters associated with the pipeline 102. Example of the parameter associated with the pipeline 102 may include all the relevant parameters that are capable of determining any leakage, future leakage or any attempt of theft in the pipeline 102, such as, corrosion in the pipeline 102, strain created by internal expending force of fluid in the pipeline 102, condition of peripheral interface of the pipeline 102, changes in temperature, pressure, humidity, shocks, vibrations, and toxic gases along with the position along the pipeline 102, and so forth.

The scanning device 202 may be configured to map the external surface 110 of the pipeline 102 into multiple sections. The scanning device 202 may also be configured to assign at least one identifier to each of the sections of the external surface 110 of the pipeline 102. The identifier may uniquely identify each section and is unique to that particular section on the pipeline 102. The scanning device 202 may monitor the identifier(s) and store the monitored value of the identifiers into the memory device 206. Over the years the data may become invaluable because there will be accurate data relating to the integrity of the pipeline will be available. The scanning device 202 may also be configured to scan the pipeline between the first end 104 and the second end 106 of the pipeline 102.

The sensors 204 of the scanning device 202 may sense and monitor the parameters associated with the pipeline 102. The scanning device 202 may be configured to identify security breaches in the pipeline 102 by using suitable methods. For example, the scanning device 202 may identify crack and structural damage via non-microscopic methods such as, but not limiting to, resonant frequency, piezoelectric paint sensors and ultrasound. The sensors 204 may be configured to measure real time data for monitoring the parameters of the sections of the pipeline 102 at pre-defined intervals. For example, the sensors 204 may measure the real time data weekly, daily, monthly, yearly, and so forth. In some embodiments, an administrator or a user may define the time or duration for scanning or measuring the real time data of the pipeline 102. The sensors 204 may also be configured to predict future leakage in the pipeline 102 based on the measured real time data. The real time data for estimating future leakage of the pipeline 102 may include, but not limiting to, corrosion in the pipeline 102, strain created by internal expending of the pipeline 102, condition of peripheral interface of the pipeline, changes in temperature, pressure, humidity, shocks, vibrations, presence of toxic gases along with the position along the pipeline 102.

The scanning device 202 may also be configured to monitor parameters of the pipeline 102 for predicting future leakage at one or more sections of the pipeline 102 for enabling preventing maintenance of the pipeline 102 at the one or more sections. Further, the scanning device 202 may be configured to measure real time data relating to security breach along the pipeline 102. The real time data relating to the security breach may include, such as, but not limiting to, tempering, damage or rupture of the pipeline 102 and position thereof along the pipeline. Through measured real time data the data processing device 112 can derive related information associated with the pipeline for identifying health of the pipeline 102.

The communication device 208 may be configured to enable communication of the movable monitoring device with other devices such as the data processing device 112 or a satellite for further processing of the real time data. In some embodiments, the communication device 208 may include a Global Positioning System (GPS) device for coordinating with a GPS satellite and to enable communication with the data processing device 112.

The data processing device 112 may be configured to perceive the real time data of the parameters of the pipeline 102 and process the same to generate real time information associated with the pipeline 102 based on the real time data. The data processing device 112 may be configured to compare the related information of the pipeline with pre-stored data in the memory device 206.

The real time data related to the pipeline 102 may include pipeline leakage data, predict future leakage or failure data, and detect any attempt to theft or tempering related data in the pipeline 102.

The signaling device 210 may be configured to generate an alarming signal in event of leakage or security breach of the pipeline 102. The alarming signal may include, but not limiting to, an audio signal, a smoke signal, visual light signal, and combination of these. For example, based on the measured data of the parameters, if the monitoring device 200A identifies leakage or crack in the pipeline 102 then an audio signal is generated so that the concerned user or administrator may take a preventive action.

In some embodiments, a movable monitoring device 200B may include a data processing device 212 similar in function to the data processing device 212 as shown in FIG. 2B.

The data processing device 212 may be configured to receive the real time data via the communication device 208. The data processing device 212 may process the monitored parameters and their values for generating the real time data relating to the pipeline 102. Further, the data processing device 212 may be configured to process the real time data for generating related information of the pipeline. Based on the information, leakage, security breach etc. in the pipeline may be detected or identified by the movable monitoring device 200A-200B.

Further, the pipeline failure may be minimized as the scanning device 202 may provide information about the health of the pipeline 102 with high level of accuracy and calculate the failure data delivering the ultimate pipeline real time failure mapping based on the measured real time data.

In some embodiments, each of the devices 202-212 as shown in FIGS. 2A-2B, may include a top protective casing and a bottom protective casing, and at least one flexible composite layer disposed between the top and bottom protective casings. Further, each of the devices 202-212 of the movable monitoring device 200B (or 200A) may include at least one layer of electronic circuitry embedded on the flexible composite layer. The electronic circuitry may include a plurality of microchips embedded on each layer of the electronic circuitry. In some embodiments, the sensors 204 are nanosensors being embedded on the flexible composite layer in coupling relationship with the electronic circuitry and microchips. A combinational arrangement of the nanosensors, the electronic circuitry and microchips on the flexible composite layer may monitor a number of parameters associated with the pipeline and generates various real time data, such as mentioned above. Example of the parameter associated with the pipeline 102 may include all the relevant parameters that are capable of determining any leakage, future leakage or any attempt of theft in the pipeline 102, such as, corrosion in the pipeline, strain created by internal expending force of fluid in the pipeline 102, condition of peripheral interface of the pipeline 102, changes in temperature, pressure, humidity, shocks, vibrations, and toxic gases along with the position along the pipeline 102, and so forth.

In some embodiments of the present disclosure, a dielectric coating layer may be coated over the flexible composite layer to protect the flexible composite layer and the combinational arrangement of the nanosensor, the electronic circuitry and microchips.

The top and bottom protective casings may accommodate the flexible composite layer therewithin in very secure and protective manner from any outside unwanted source, thereby making the monitoring device 200A-200B full-proof. In FIGS. 2A and 2B, the devices 202-212 are illustrated for understanding purpose and may not be considered to be limiting to that the movable monitoring device 200 (or 108) can include more devices or modules, which can vary as per the customers and industry requirement.

In some embodiments, the flexible composite layer in one or more devices 202-212 may be graphene nanosheet formed using the intelligent Polyethylene Terephthalate (PET). Further, the nanosensors, for example, may be smart transistor nanosensors. The smart transistor nanosensors, electronic circuitry, and the microchips may be printed over the graphene nanosheet with closed coordination while maintaining sensors' tolerances, escalation mechanisms forming a crystal lattice structure of a matrix of the combinational arrangement of the electronic circuitry, the microchips and the sensor arrangements over the graphene nanosheet.

The sensors 204 may continuously monitor the changes in the pipeline 102 for providing real time data to the data processing device 212 (or 112). Further, the sensors 204 may monitor various parameters related to pipeline leakage, predict future leakage or failure, and detect any attempt to theft or tempering in the pipeline 102, generating real time data to send it to the data processing device 212. The data processing device 212 may generate various information that help in making prediction of future failure of the pipeline 102 and also information related to present leakage and theft attempt. Based on the information, the signaling device 210 may generate an alarm or alarming signal to concerned authorities/administrators/users. The parameter that may be monitored include, but not limiting to, corrosion in the pipeline 102, strain created by internal expending force of fluid in the pipeline 102, condition of peripheral interface of the pipeline 102, changes in temperature, pressure, humidity, shocks, vibrations, and toxic gases along with the position along the pipeline 102, and so forth.

In one embodiment, the sensors 204 (or nanosensors) may be arranged in a manner where at least one set of sensors 204 are configured to measure at least one real time data relating to pipeline leakage along the pipeline 102. The real time data relating to pipeline leakage may include fluid leakage frequency and amount, and fluid leakage position and the like. Similarly, in the combinational arrangement of the sensors 204, the electronic circuitry and the microchips, at least another one set of sensors 204 and the microchips may be configured to measure at least one real time data relating to pipeline security breach along the pipeline 102. The real time data relating security breach including, but not limited to, tempering, damage or rupture of the pipeline and position thereof along the pipeline 102.

In both the above scenarios, the movable monitoring devices 200A-200B, in such embodiments, may include a shutdown-valve (not shown) coupled to the pipeline 102, which may be actuated via the sensors 204 and/or the microchips in event of the leakage or tempering, damage or rupture of the pipeline.

The nanosensors or the sensors 204 may be configured to measure at least one real time data to regularly monitor general parameters of the pipeline 102 and predict future leakage to enable preventive maintenance of the pipeline 102 at that location. The real time data relating to estimated future leakage and regular monitoring of the pipeline 102 may include, but not limiting to, corrosion in the pipeline, strain created by internal expending force of fluid in the pipeline 102, condition of peripheral interface of the pipeline 102, changes in temperature, pressure, humidity, shocks, vibrations, toxic gases along with the position along the pipeline 102, and the like.

In some embodiments, one or more of the sensors 204 are position sensors. Such position sensors in coordination with the electronic circuitry may be capable of coordinating with all set of sensors 204 and/or the microchips and send relevant data and position along the pipeline 102 to the data processing device 212 (or 112). In one embodiment, such position sensors may be a GPS (Global Positioning System) that is adapted to coordinate with a GPS satellite to enable the communication between the devices 202-212 and the data processing device 212.

In some embodiments, the movable monitoring device 200A-200B (hereinafter may be referred as 200 due to similarity in function and structure) may include at least one failsafe layer configured on the flexible composite layer. The failsafe layer may include a number of photonics boxes on the flexible composite layer in coordination with the combinational arrangement of the sensors 204, the electronic circuitry and the microchips. The photonics boxes may be actuated via voltage to generate information signals in event of leakage, security breach, breakage and monitoring of the pipeline 102 on real time basis, thereby making failsafe pipeline. The photonics boxes in the failsafe layer may include transmitting and receiving devices disposed at distal ends of the movable monitoring device 200 (or 108), which are capable of transmitting and receiving laser lights through a fiber optics cable in the movable monitoring device 200 (or 108) in the event of any breach in the pipeline 102, the photonics boxes are in coordination with the sensors etc., generates information signals until the primary system is restored. The failsafe layer with the photonic boxes may be capable of generating a single line or several lines with multi layers disposed on the flexible composite layer.

In some embodiment, the movable monitoring device may further include a layer of photovoltaic arrangement disposed on the flexible composite layer in coordination with the combinational arrangement of the sensors 204 and other devices 206-212, the electronic circuitry and the microchips to generate required voltage for the operation of the photonics boxes and the flexible composite layer as described above.

Further, the signaling device 210 may include at least alarming microchip with an integrated software, which in combination of the sensors 204 is adapted to generate alarming signal, in event of leakage or security breach of the pipeline. The signal may be audio, smoke or visual lights.

In any event of failure or leakage of the pipeline 102, the movable monitoring device 200 with the help of integrated devices 202-212, specifically, the combinational arrangement of the sensors 204, is capable of generating real time data at the site of conflicts of the pipeline 102, and sends only relevant data to the data processing device 212 or a server device via the communication device 208, in turn reducing the processing load on the data processing device 212 or a server device located at a remote site in communication with the monitoring device 200. Alternatively, the movable monitoring device 200 is capable of generating real time data at the site of conflicts of the pipeline 102 and sends all data to the data processing device 212 via the communication device 208, if required.

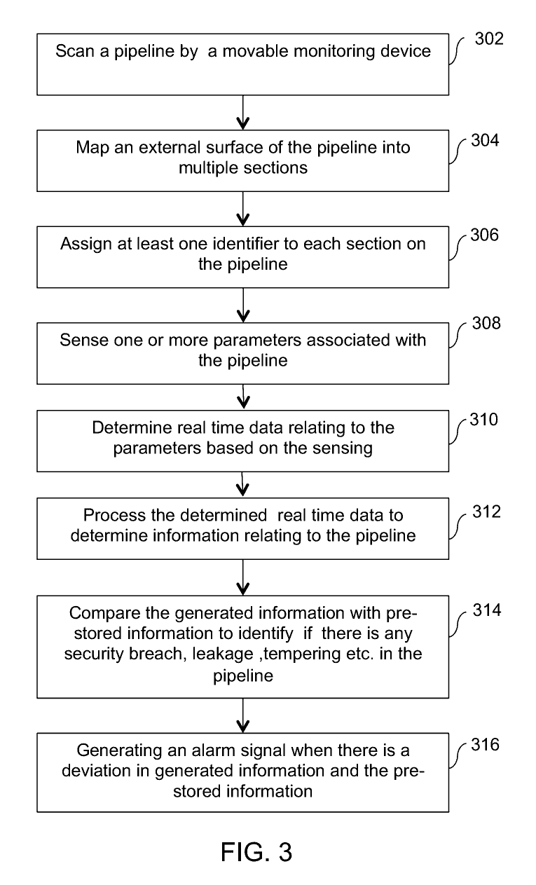

FIG. 3 is a flowchart illustrating an exemplary method 300 for monitoring and managing a pipeline, in accordance with an embodiment of the present disclosure. As discussed with reference to FIGS. 1A-1B, the movable monitoring device 108A-108B (or 200A-200B) may not or may include the data processing device 112 (or 212), respectively. Further, the movable monitoring device 200A may include the scanning device 202 including the sensors 204, the memory device 206, the communication device 208, and the signaling device 210. The movable device 200B may include the data processing device 212 and the devices of the movable monitoring device 200A.

At step 302, the movable device 200B may scan the external surface 110 of the pipeline 102. In some embodiments, the scanning device 202 including the sensors 204 may scan the external surface 110 of the pipeline 102. The sensors 204 may be configured to scan the external surface 110 of the pipeline 102 longitudinally from the first end 104 to the second end or vice versa. In some embodiments, the sensors 204 of the scanning device 202 may be configured to scan the pipeline 102 circumferentially.

At step 304, the pipeline 102 is mapped onto or divided into multiple sections. In some embodiments, the scanning device 202 may map the sections on the pipeline 102. Then at step 306, at least one identifier is assigned to the sections of the pipeline 102. The identifier may be unique to a particular section of the pipeline 102.

At step 308, one or more parameters of the pipeline 102 are sensed. In some embodiments the scanning device 202 or the sensors 204 may sense the one or more parameters of the pipeline 102. Example of the parameter associated with the pipeline 102 may include all the relevant parameters that are capable of determining any leakage, future leakage or any attempt of theft in the pipeline 102, such as, corrosion in the pipeline 102, strain created by internal expending force of fluid in the pipeline 102, condition of peripheral interface of the pipeline 102, changes in temperature, pressure, humidity, shocks, vibrations, and toxic gases along with the position along the pipeline 102, and so forth.

At step 310, real time data is determined based on the sensing of the parameters. The scanning device 202 may determine the real time data based on the sensing. Then at step 312, the real time data is processed to determine or generate information relating to the pipeline 102. In some embodiments, the data processing device 212 or 112 may process the real time data.

Thereafter, at step 314, the generated information is compared with pre-stored information in the memory device 206 of the monitoring device 200 to identify any deviation in the information. In some embodiments, the data processing device 212 may compare the generated information with the pre-stored information. The memory device 206 may store data or information about health of the pipeline 102 and the parameters associated with the pipeline 102.

In case a deviation is identified at step 314 based on the comparison then an alarming signal is generated at step 316. In some embodiments, the alarming signal may be an audio signal, a visual signal, a message, smoke signal, and combination of these. Further, the signaling device 210 may generate the alarming signal. Based on the alarming signal concerned authorities or an administrator may take a preventive action for protection of the pipeline 102.

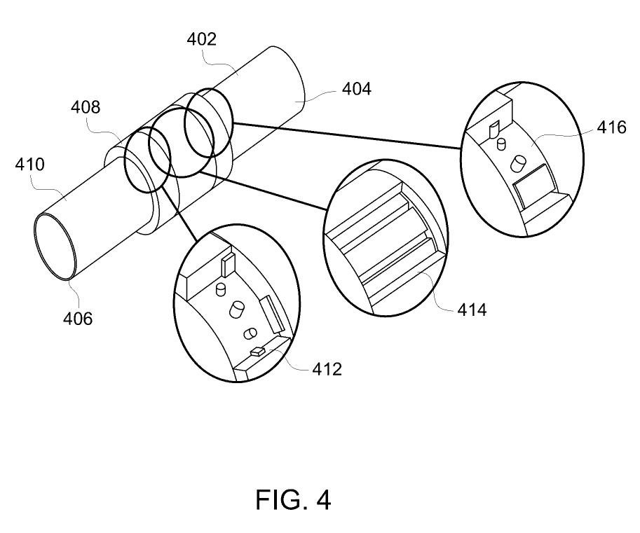

FIG. 4 is a schematic diagram illustrating an exemplary movable monitoring device 408 being fitted on a pipeline 402, in accordance with an embodiment of the present disclosure. As shown, the pipeline 402 may have a first end 404 and a second end 404. The movable monitoring device 408 may be configured to move over an external surface 410 of the pipeline 402. The monitoring device 408 may be configured to move longitudinally between the two ends 404-406. The movable monitoring device 408 may also be configured to move circumferentially with respect to a central axis of the pipeline 402.

The movable monitoring device 408 may be configured to scan the pipeline 402 by moving longitudinally and circumferentially. The movable monitoring device 408 may include a master device or module 412, a power device or module 414, and a service device or module 416. The power device/module 414 is configured to provide or supply power to the movable monitoring device 408 for it's functioning. The power device 414 may include high performance energy saving batteries that may drive the monitoring device 408. The batteries may be designed to run continuously for example, for minimum of 10 hours. In some embodiments, the performance of the batteries may improve over a period of time.

In alternate embodiments, the small fuel engines may be installed in the power device 414, however this may require considerable safety tests and industry acceptance before it may be used because of highly inflame liquids inside the pipeline 402. The power device 414 including the small fuel engines may be used over pipeline 402 including water. In some embodiments, the power device 414 may have a self-charging module or device. The power device 414 may charge the battery automatically at every charging center. The charging centers may be installed at a predefined distance on the pipeline 402. The power device 402 may also provide backup power to the monitoring device 408.

The master device 412 may include at least one quad processor for processing scanned data and matching the same with previously scanned data. The master device 412 may be a central processing unit configured to do minimal local processing and further data processing may be done at a control center located remotely or nearby. The master device 412 may include an Solid State Hybrid Drive (SSHD) for high speed local processing. The master device 412 may also include an anti-temper protection unit. The master device 412 may also include a GPS device configured to synchronize data processing with the control center. The control center may support PIR with high performance super computers with predictive machine-to-machine analytical device that may be combination of hardware, software, and so forth. The master device 412 may also be configured to generate a location map by assigning a unique address to each square inch of the pipeline.

Further, the master device 412 may be configured to image or capture pictures or videos of the pipeline 402. The master device 412 may be configured to send the video to the control center for further processing. Areas of location of failure may be identified based on the videos or pictures. The master device 412 may be similar in functionality to the data processing device 212 as discussed with reference to FIG. 2B. In some embodiments, the master device 412 may combine the functionality of the data processing device 212, the communication device 208, the signaling device 210, and the memory device 206.

The service device 416 may be configured to sense one or more parameters associated with the pipeline 402. The service device 416 may include multiple sensors (not shown) that are configured to scan and sense multiple parameters associated with the pipeline 402. Examples of the parameter associated with the pipeline 402 may include all the relevant parameters that are capable of determining any leakage, future leakage or any attempt of theft in the pipeline 402, such as, corrosion in the pipeline 402, strain created by internal expending force of fluid in the pipeline 402, condition of peripheral interface of the pipeline 402, changes in temperature, pressure, humidity, shocks, vibrations, and toxic gases along with the position along the pipeline 402, and so forth. The service device 416 may be configured to do ink markings on the pipeline 402. The service device 416 may be configured to mark up errors for detected breaches in the pipeline 402. The service device 416 may include inbuilt X-ray or CT scanning engine. The service device 416 may be configured to scan the pipeline 402 by slowly rotating around the pipeline 402 for 360 degree scanning of the pipeline 402. The data generated by scanning may be stored in a hard disc or at the master device 412. The data may be stored and processed using complex data analytics to ensure high speed data processing of high volume. The service device 416 may be similar in functionality to the scanning device 202 as discussed with reference to FIGS. 2A-2B.

The monitoring device 402 may be retrofitted on the pipeline 402 and the monitoring device 402 may be configured to travel along the pipeline 402 at low speeds. The monitoring device 402 may be configured to gain full insight into the inside of materials and structures of the pipeline 402. More commonly, cracks and structural damage may be identifier via non-microscopic methods such as resonant frequency, piezoelectric paint sensors, and ultrasound microscopic techniques can then be employed to provide further clarity and analysis to any damage to the pipeline 402.

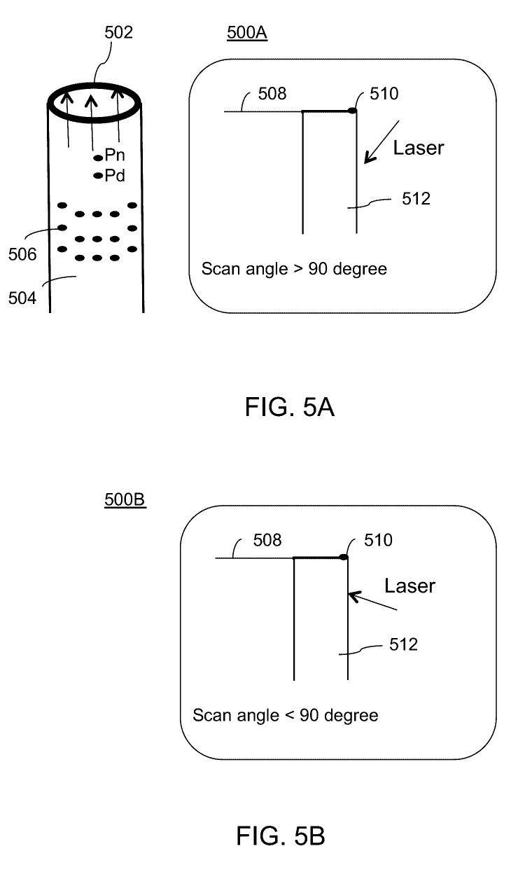

FIGS. 5A-5B are diagrams illustrating scanning of a pipeline 502 at various angles by a movable monitoring device, in accordance with different embodiments of the present disclosure. A graphical representation 500A shows the pipeline 502 with dots being scanned at scanning angle greater than 90 degrees. A graphical representation 500B shows the scanning angle less than 90 degrees. The scanning device or the service device 416 may maps each section of the entire pipeline 502 and assigns them a unique identifier. The identifier remains unique to each section or specific part of the pipeline 502. A monitoring device for example, monitoring device 408 may monitor each of the identifiers and compare the scanned data against data of previous scans. Over years this data may become invaluable because company of the pipeline 502 may have accurate data they causes failures in the pipeline 502 from external or internal factors. Hence, the pipeline failures may become almost nominal because the scanner can give the health of the pipeline 502 with high level of accuracy and may calculate the failure data and delivering the pipeline 502 real time failure mapping.

The system of the present disclosure is advantageous in various scopes. The system preclude conventional technique of generation of limited information related to pipelines and provides integrated pipeline monitoring and protection system, which is capable of offering real time monitoring and protection of the entire pipeline regarding leakage, theft or predict even future leakage and enables to take preventive measures to avoid such leakage. Further, the device of the present disclosure may be installed or fitted anywhere along the entire pipeline to enable pipeline integrity in terms of protection of the entire pipeline as against the available prior-art technologies which are largely based on the protection or presentation of specific regions of the pipeline. Furthermore, the module of the present disclosure may be capable of monitoring, if required, all the relevant parameters of the pipelines in a cost effective manner as against the available prior-art technologies where specific tools or methods are incorporated on the pipeline which are only required in that region of the pipeline because of huge costing involved in installing all the tools and methods at each location of the pipelines. Moreover, the module or system of the present disclosure is capable of generating real time data of the pipeline and at the same time reduce the processing load on a central control unit. Various other advantages and features of the present disclosure are apparent from the above detailed description and appendage claims.

A computer program product including program instructions tangibly stored on a computer-readable medium and operable to cause a computer system to perform the method disclosed herein may be an application software that enables a computing device to capture unique strings included within identifiers being broadcasted by a wireless access device. The unique identifier may be an SSID. The application program may further provide an interface that permits the user to choose and attach specific unique strings to the content being posted on social media. In an alternate embodiment the application software may be configured to automatically post content on pre designated social media platforms along with the chosen unique strings attached to such content.

It will be understood that the devices and the databases referred to in the previous sections are not necessarily utilized together method or system of the embodiments. Rather, these devices are merely exemplary of the various devices that may be implemented within a computing device or the server device, and can be implemented in exemplary another devices, and other devices as appropriate, that can communicate via a network to the exemplary server device.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

The terminology used herein is for the purpose of describing particular embodiments only and is not intended to be limiting of the disclosure. It will be appreciated that several of the above disclosed and other features and functions, or alternatives thereof, may be combined into other systems, methods, or applications. Various presently unforeseen or unanticipated alternatives, modifications, variations, or improvements therein may subsequently be made by those skilled in the art without departing from the scope of the present disclosure as encompassed by the following claims.

What is claimed is:

1. A pipeline monitoring and managing system, comprising:
a movable monitoring device configured to scan a pipeline including a first end and a second end, wherein the movable monitoring device is disposable circumferentially onto an external surface of the pipeline, the movable monitoring device further comprises:
a scanning device comprising a plurality of sensors, the scanning device is configured to:
scan the external surface of the pipeline between the first end of the pipeline and the second end of the pipeline; and
sense and monitor a plurality of parameters associated with the pipeline; and
a data processing device communicably coupled to the movable monitoring device, and configured to receive the plurality of parameters associated with the pipeline and generate a plurality of related information of the pipeline based on the plurality of parameters.

2. The pipeline monitoring and managing system of claim 1, wherein the movable monitoring device further comprising at least one of a master device, a power device, and a service device.

3. The pipeline monitoring and managing system of claim 1, wherein the movable monitoring device is further configured to scan the pipeline by moving longitudinally between the first end and the second end of the pipeline.

4. The pipeline monitoring and managing system of claim 3, wherein the movable monitoring device is configured to scan the pipeline by moving circumferentially over the external surface of the pipeline.

5. The pipeline monitoring and managing system of claim 4, wherein the scanning device is configured to map the external surface of the pipeline into a plurality of sections and assign an identifier to each of the plurality of sections, wherein the plurality of identifiers uniquely identifies the plurality of sections.

6. The pipeline monitoring and managing system of claim 5, wherein the plurality of sensors are configured to:
measure at least one of a plurality of real time data for monitoring the plurality of parameters of the plurality of sections of the pipeline at pre-defined intervals; and
predict future leakage in the pipeline based on the measured plurality of real time data, wherein the real time data for estimating future leakage of the pipeline comprising corrosion in the pipeline, strain created by internal expending force of fluid in the pipeline, condition of peripheral interface of the pipeline, changes in temperature, pressure, humidity, shocks, vibrations, toxic gases along with the position along the pipeline.

7. The pipeline monitoring and managing system of claim 6, wherein the scanning device is further configured to monitor the plurality of parameters of the pipeline to predict future leakage at one or more sections of the plurality of sections for enabling preventive maintenance of the pipeline at the one or more sections.

8. The pipeline monitoring and managing system of claim 7, wherein the scanning device is further configured to measure at least one of the real time data relating to pipeline security breach along the pipeline, wherein the real time data relating security breach comprising tempering, damage or rupture of the pipeline and position thereof along the pipeline.

9. The pipeline monitoring and managing system of claim 7, wherein the scanning device is further configured to check for a pipeline security breach along an entire length of the pipeline, the real time data relating security breach comprising tempering, damage or rupture of the pipeline and position thereof along the pipeline.

10. The pipeline monitoring and managing system of claim 9, wherein in the movable monitoring device further comprises a communication device including at least one of a Global Positioning System (GPS) device for coordinating with a GPS satellite to enable the communication with the data processing device.

11. The pipeline monitoring and managing system of claim 10, wherein the movable monitoring device further comprises a signaling device configured to generate an alarming signal in event of leakage or security breach of the pipeline, wherein the alarming signal comprising at least one of an audio, smoke, and visual lights.

12. The pipeline monitoring and managing system of claim 11, wherein the movable monitoring device further comprises a memory device for storing the data, and the plurality of related information of the pipeline.

13. The pipeline monitoring and managing system of claim 12, wherein the data processing device is configured to compare the related information of the pipeline with pre-stored data.

14. A pipeline monitoring and protection device comprising:
a scanning device comprising one or more sensors, the scanning device is configured to:
scan an external surface of a pipeline including a first end and a second end;
sense and monitor a plurality of parameters associated with the pipeline; and
a memory device configured to store the plurality of real time data; and
a data processing device configured to:
determine a plurality of real time data relating to the pipeline based on the sensing of the parameters;
process the plurality of real time data relating to the pipeline for generating a plurality of related information of the pipeline;
wherein the pipeline monitoring and protection device is adapted to fit circumferentially onto the external surface of the pipeline, further wherein the pipeline monitoring and protection device is configured to move longitudinally between the first end and the second end of the pipeline and to move circumferentially with reference to a central axis of the pipeline.

15. The pipeline monitoring and protection device of claim 14, wherein the scanning device is configured to map the external surface of the pipeline into a plurality of sections and assign an identifier to each of the plurality of sections, wherein the plurality of identifiers uniquely identifies the plurality of sections.

16. The pipeline monitoring and protection device of claim 15, wherein the plurality of sensors are configured to:
measure at least one of a plurality of real time data for monitoring the plurality of parameters of the plurality of sections of the pipeline at pre-defined intervals; and
predict future leakage in the pipeline based on the at least one of the plurality of real time data, wherein the real time data for estimating future leakage of the pipeline comprising corrosion in the pipeline, strain created by internal expending force of fluid in the pipeline, condition of peripheral interface of the pipeline, changes in temperature, pressure, humidity, shocks, vibrations, toxic gases along with the position along the pipeline.

17. The pipeline monitoring and protection device of claim 16, wherein the scanning device is further configured to monitor the plurality of parameters of the pipeline and predict future leakage at one or more sections of the plurality of sections for enabling preventive maintenance of the pipeline at the one or more sections.

18. The pipeline monitoring and protection device of claim 17, wherein the scanning device is further configured to measure at least one of the real time data relating to pipeline security breach along the pipeline, wherein the at least one real time data relating security breach comprising tempering, damage or rupture of the pipeline and position thereof along the pipeline.

19. The pipeline monitoring and protection device of claim 18, wherein the scanning device is further configured to check for a pipeline security breach along an entire length of the pipeline, wherein the real time data relating to the pipeline security breach comprising tempering, damage or rupture of the pipeline and position thereof along the pipeline.

20. The pipeline monitoring and protection device of claim 19 further comprising a signaling device configured to generate an alarming signal in event of at least one of a leakage and security breach of the pipeline, wherein the alarming signal comprising at least one of an audio, smoke, and visual lights.

21. The pipeline monitoring and protection device of claim 14, wherein the data processing device is further configured to compare the plurality of related information of the pipeline with data previously stored in the memory device.

22. A method of making a pipeline monitoring and managing system, comprising:
providing a movable monitoring device configured to scan the pipeline, wherein the movable monitoring device is disposable circumferentially onto an external surface of a pipeline, the movable monitoring device further comprises a scanning device including one or more sensors, the scanning device is configured to:
scan the external surface of the pipeline; and
sense and monitor a plurality of parameters associated with the pipeline; and
providing a data processing device, wherein the data processing device is communicably coupled to the movable monitoring device for receiving the plurality of parameters associated with the pipeline and generating a plurality of related information of the pipeline based on the plurality of parameters.

23. A method for pipeline monitoring and managing system, comprising:
scanning, by a movable monitoring device, a pipeline, wherein the movable monitoring device is fitted on an external surface of the pipeline and is configured to move over the external surface of the pipeline;
mapping, by a scanning device of the movable monitoring device, the external surface into a plurality of sections;
assigning, by the scanning device, at least one identifier to each of the plurality of sections;
sensing, by scanning device, one or more parameters associated with the pipeline;
determining, by a data processing device of the movable monitoring device, at least one real time data based on the sensing of the one or more parameters;
processing, by the data processing device, the at least one real time data for generating at least one information relating to the pipeline;
comparing, by the data processing device, the generated information with pre-stored information of the pipeline for identifying any deviation in the information, wherein the pre-stored information is stored in a memory device of the movable memory device; and
generating, by a signaling device, an alarming signal when the deviation is identified in the information, wherein the alarming signal comprises at least one of an audio signal, a smoke signal, a visual signal, a light signal, and a message.
